(19) United States
(12) Patent Application Publication
(10) Pub. No.: US 2016/0139856 A1
(43) Pub. Date: May 19, 2016

(54) Synchronized Order Batching Mechanism

(71) Applicants: Erik J. Fritz, Thornton, CO (US); Joseph P. Gaertner, Lafayette, CO (US); Lisa M. Oakleaf, Arvada, CO (US); Lance Jones, Lafayette, CO (US); Marcel Stoica, Timisoara (RO)

(72) Inventors: Erik J. Fritz, Thornton, CO (US); Joseph P. Gaertner, Lafayette, CO (US); Lisa M. Oakleaf, Arvada, CO (US); Lance Jones, Lafayette, CO (US); Marcel Stoica, Timisoara (RO)

(73) Assignee: Ricoh Company, Ltd., Tokyo (JP)

(21) Appl. No.: 14/543,219

(22) Filed: Nov. 17, 2014

(51) Int. Cl. G06F 3/12; G06K 15/00; H04L 29/08

(52) U.S. Cl. CPC G06F 3/1204; H04L 67/10; G06F 3/1219; G06F 3/1262; G06F 3/1285; G06F 3/1296; G06K 15/007

(57) ABSTRACT

A method disclosed. The method includes receiving a plurality of jobs at a printing environment, collecting a first set of the plurality jobs at a first filter based on one or more job properties, generating a first batch of one or more jobs to be processed from a first set of jobs in the first filter based on one or more job properties specified in a first sub-filter component of the first filter and generating a second batch of one or more jobs to be processed from a second set of jobs in the first filter based on one or more job properties specified in a second sub-filter component of the first filter.

### FIELD OF THE INVENTION

The invention relates to the field of computer systems, and in particular, to printing software products.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer. Once a connection is established between a workstation and the printer, printing software is implemented at a print server to manage a print job from order entry and management through the complete printing process.

The printing software often includes a graphical user interface (GUI) that enables users to control the printing process. In high speed production printing environments, it is often necessary for an operator to separate jobs in multi-part orders to batch them for production efficiency. However, the operator may also need to keep track of these jobs for later re-assembly. Currently, sorting and routing of orders is a manual process.

Accordingly, it would be advantageous to provide a print scheduling mechanism that features visibility, automation and metrics for the efficient printing and finishing large amounts of orders in order to reduce wastes (e.g., time and paper waste).

### SUMMARY

In one embodiment, a method includes receiving a plurality of jobs at a printing environment, collecting a first set of the plurality jobs at a first filter based on one or more job properties, generating a first batch of one or more jobs to be processed from a first set of jobs in the first filter based on one or more job properties specified in a first sub-filter component of the first filter and generating a second batch of one or more jobs to be processed from a second set of jobs in the first filter based on one or more job properties specified in a second sub-filter component of the first filter.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIGS. 2A & 2B illustrates a screen shot of one embodiment of a graphical user interface;

FIG. 3 is a flow diagram illustrating one embodiment for processing work orders;

FIGS. 4A-4C illustrate screen shots of another embodiment of a graphical user interface; and

FIG. 5 illustrates one embodiment of a computer system.

### DETAILED DESCRIPTION

A print scheduling mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

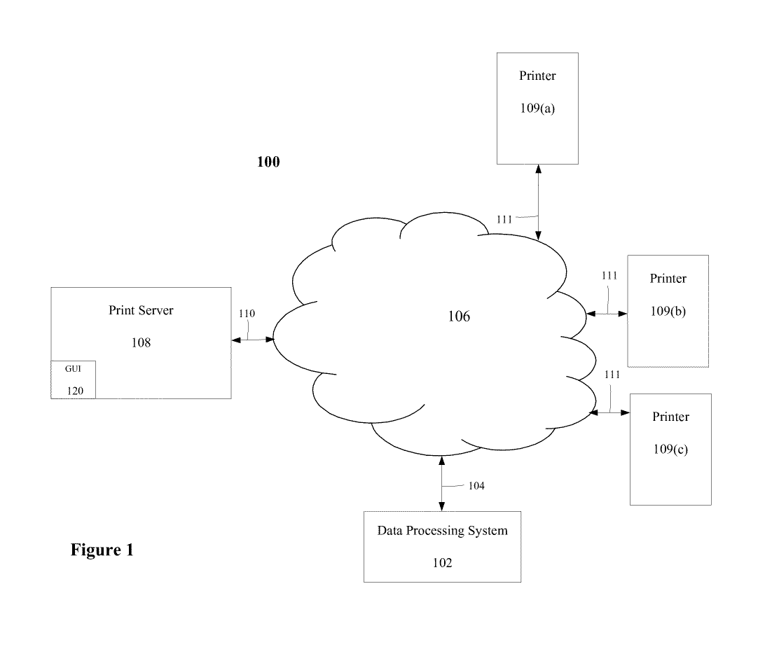

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes print server 108 that serve print requests over network 106 received via communications link 110. Print server 108 subsequently transmits the print requests via communications link 110 to one of printers 109 for printing, which are coupled to network 106 via communications links 111. In one embodiment, an operator at data processing system 102 may interact with print server 108 using a GUI 120 to submit requests for service to one or more of printers 109 over network 106.

Although described as separate entities, other embodiments may include a print server 108 being incorporated in one or more of the printers 109. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the processing (e.g., printing) of documents from data processing system 102 to one or more of printers 109. In other embodiments, the printing software manages printing of documents from multiple data processing systems 102 to printers 109.

According to one embodiment, the printing software product may be implemented using either TotalFlow Print Manager or TotalFlow Production Manager, although other types of printing software may be used instead. In a further embodiment, the printing software product includes GUI 120 that enables a system administrator (or operator) to interact with the print printing software product at printer servers 108.

According to one embodiment, GUI 120 enables an operator to instantly view all jobs that meet specific job properties based on printing, finishing, paper and operator defined fields. In such an embodiment, a job may be defined as a unit of work (e.g., one or more files) to be processed at printer 109. In a further, embodiment, GUI 120 includes filter and batch views that enables the operator to make decisions on volume metrics that are defined, and create filter scenarios for optimal efficiency. In this embodiment, filters defined by an operator collect jobs with specific processing options in any order, while batches can be created (either manually or automatically) from these filters of jobs when a defined threshold or volume range is met.

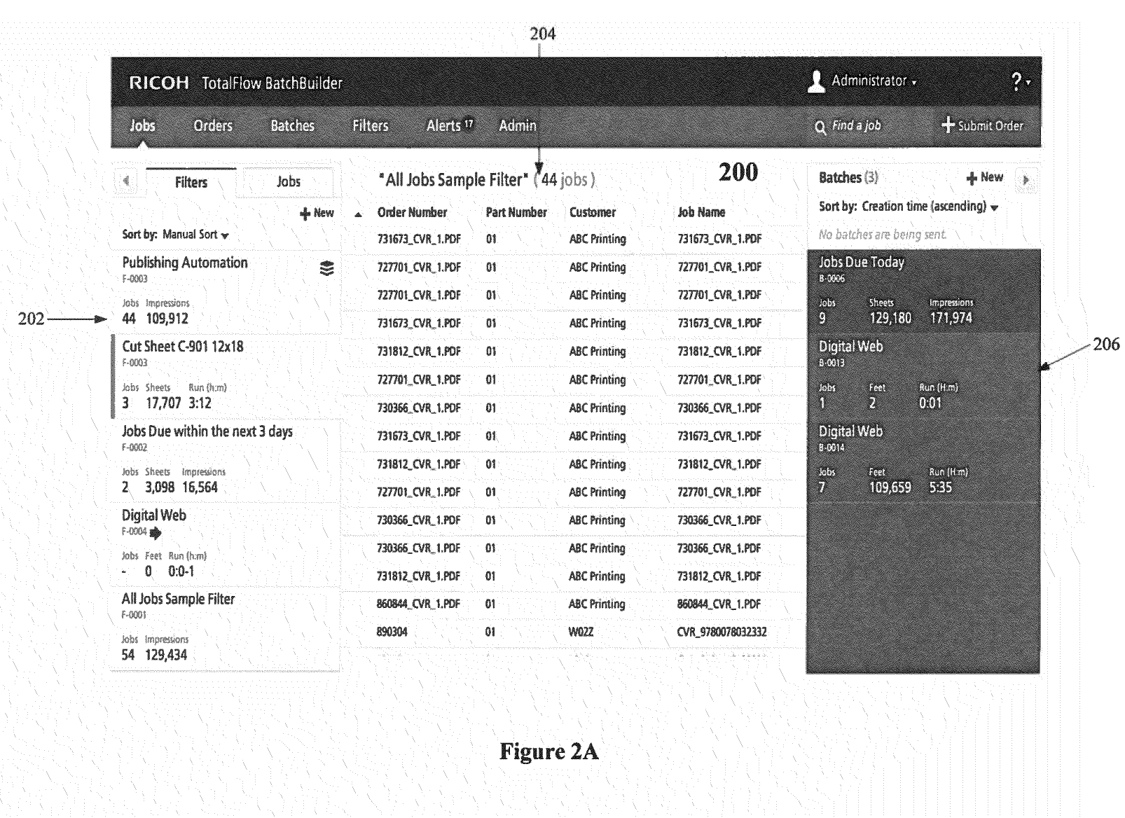

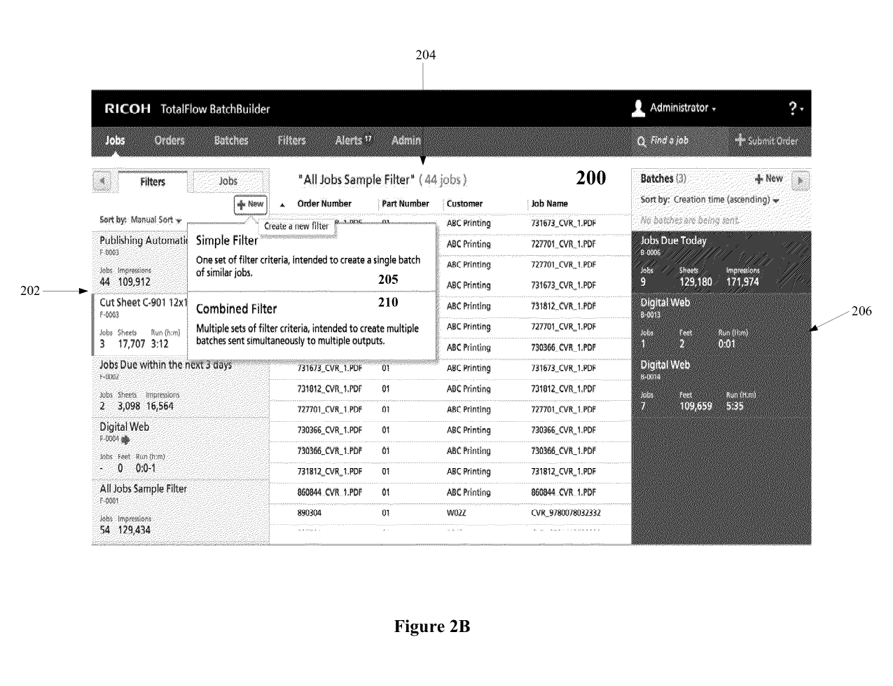

FIG. 2A illustrates a screen shot of one embodiment of a GUI window 200. Window 200 enables an operator to view all jobs in matching filters, which enables generation of batches to be forwarded to one or more output devices (e.g., a printer, an imposition hot folder or directory on a network). Window 200 includes a filters area 202, a jobs grid 204 and batching panel 206.

According to one embodiment, filters area 202 provides a view of statistics (e.g., number of sheets, jobs, run time, etc.,) of various operator defined filters. Filters area 202 simulates how jobs could be printed, finished or imposed together without altering files, thus providing the operator a choice or scenario of how to optimize the production process.

Upon selection, jobs within a filter are displayed in jobs grid 204 along with various corresponding attributes (e.g., job name, sheets, copies, etc.). In a further embodiment, all pending jobs may be displayed in jobs grid 204 upon selection of the jobs tab in filters area 202. Based on filters shown in filter area 202, the operator may make decisions based on the results. For instance, the operator may automatically and/or manually batch work. Batched jobs are displayed in batching panel 206.

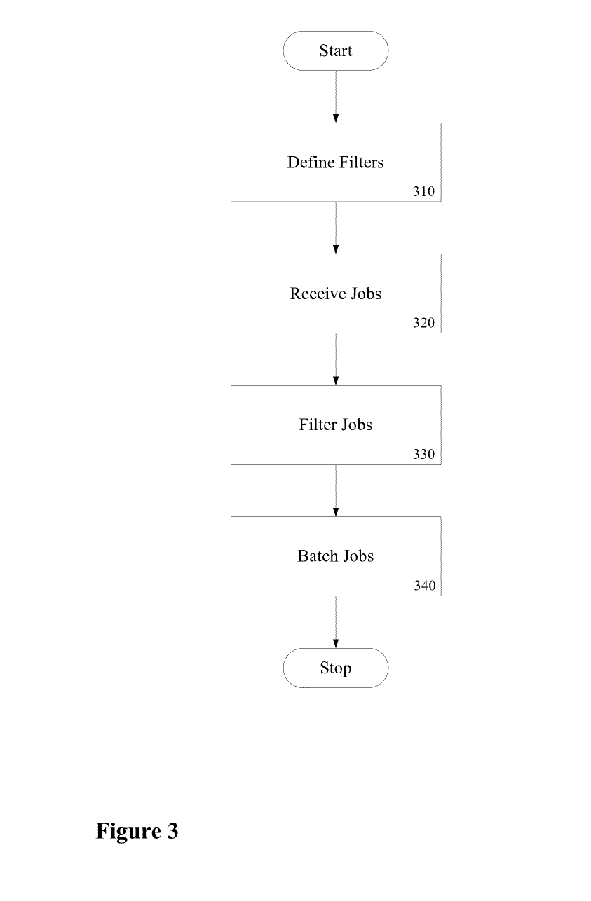

FIG. 3 is a flow diagram illustrating one embodiment for processing work orders. At processing block 310, filters are defined. According to one embodiment, an operator can define a filter to match one or more job properties (e.g., media attributes, finishing attributes, lamination attributes, binding attributes, custom attributes, etc.). In such an embodiment, operators (e.g., =, !=, >, <, ≦, ≧) may be used for matching.

In a further embodiment, an operator may select from between a simple filter and a combined filter. In such an embodiment, a simple filter provides one set of filter criteria intended to generate a single batch of similar jobs, while the combined filter provides multiple sets of filter criteria intended to generate multiple batches to be simultaneously transmitted to multiple outputs. In one embodiment, a combined filter is implemented to synchronize (or link) production of multiple orders that are produced in different batches.

FIG. 2B illustrates a screen shot of one embodiment of a GUI window 200 including simple filter 205 and combined filter 210 upon selection of a filter button in GUI window 200. According to one embodiment, a combined filter set includes an identification number shared by multiple generated batches of jobs generated by the combined filter to enable tracking. Thus, a connection between each of two or more order components may be maintained throughout print production.

For example, in embodiments in which a printer 109 is used as a publishing printer to produce text books, separate jobs may be generated to produce the text book covers, while others are generated to produce text. In such an embodiment, a combination filter may be defined to search for attribute criteria of a cover component (e.g., file name) to find every job that matches the attribute (e.g., includes cover in the file name). Additionally, the combination filter may be defined to similarly search for text component criteria attributes (e.g., 8½ paper size, etc.). Accordingly, received jobs that meet the criteria are filtered according to the combination filter.

In one embodiment, the filtered jobs are validated against an identification (or order) number to enable all covers that correspond to the filtered text files to be pulled for synchronization (e.g., each of a multitude of covers match corresponding text files). As a result, an operator can maintain relationships of multi-part orders and easily identify order components throughout the production process for re-assembly.

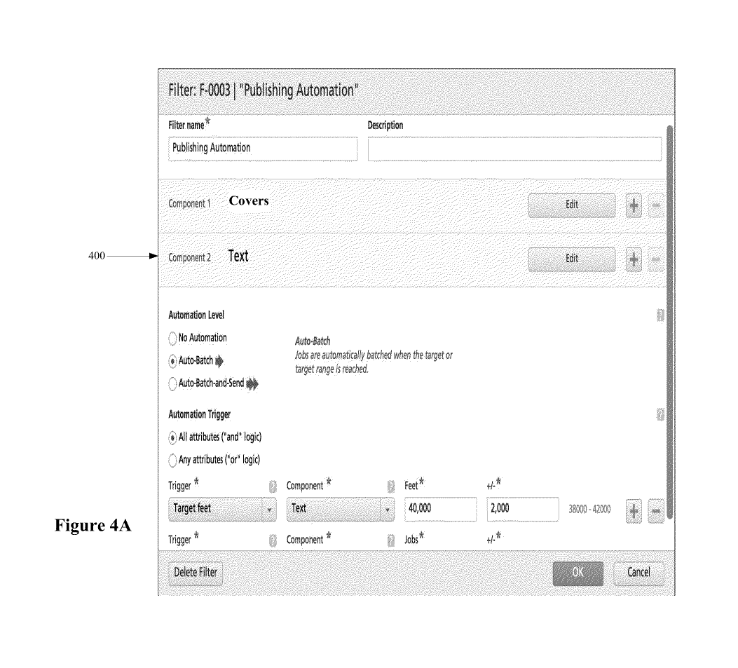

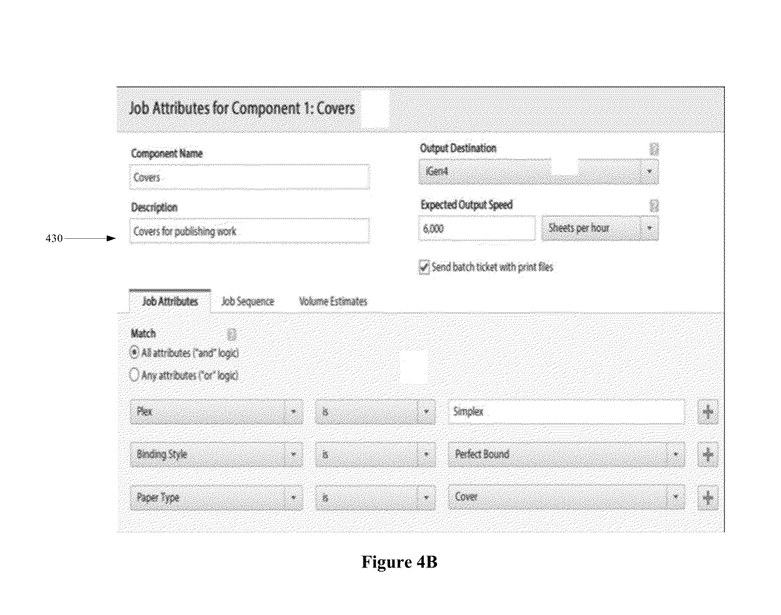

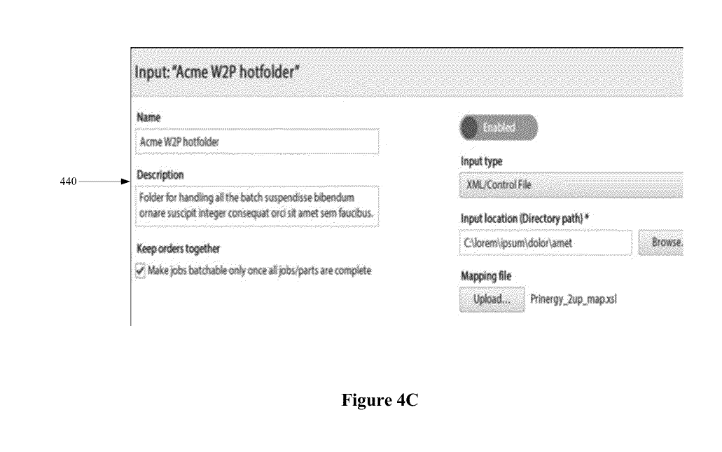

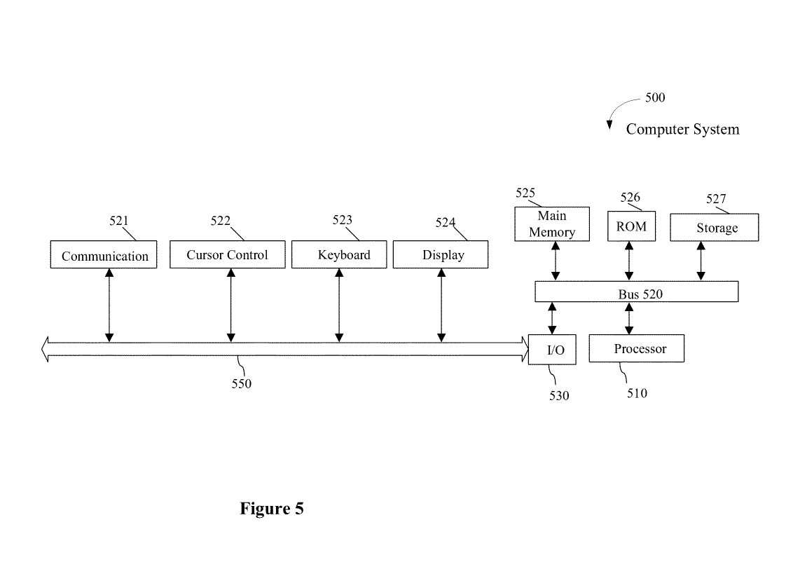

FIG. 4A illustrates a screen shot of one embodiment of a GUI window 400 implemented to define a combined filter. Window 400 enables a combined filter to be defined based on job attributes for each of two or more filter components (or sub-filters), as well as output destination for each component. As shown in FIG. 4A, a “Publishing Automation” filter is defined using window 400, which includes a “Covers” component and “Text” component.

An operator may select a corresponding button to edit a component in order to select one or more attribute criteria. Additionally, the operator may set an automation level (e.g., auto batch, auto batch and send, etc.) that is occur upon the occurrence of a selected automation trigger (e.g., time of day, run time, etc.) for batch generation. Selection of the Auto-Batch option automatically batches matching jobs upon occurrence of the automation trigger. Upon selection of Auto-Batch-and-Send option, matching jobs are automatically batched and forwarded to a selected output destination upon occurrence of the automation trigger.

FIG. 4B illustrates a screen shot of such an embodiment of a GUI window 400 upon an operator selecting the button to edit the Covers filter component. As shown in FIG. 4B, the operator may set various attribute criteria for the filter component. According to one embodiment, an operator may also set automation triggers using volume estimates (e.g., job run time, sheets, impressions, file size, etc.) by selecting a volume estimates tab.

In a further embodiment, the GUI enables orders entering the system to be synchronized by checking an input box on the input dialog. Such option prevents the system from filtering any part of the order until all are ready to be batched. FIG. 4C illustrates a screen shot of such an embodiment of a GUI window 440 that includes a selection box which, when selected, makes jobs batchable only when processing of the jobs/parts have been completed. Otherwise, jobs matching criteria are placed in filters area 202 if the selection box is not selected.

Referring back to FIG. 3, jobs are received after the filters have been defined, processing block 320. At processing block 330, jobs matching the defined filters are displayed at filter area 202. At processing block 340, the jobs may be batched based on job properties. In one embodiment, jobs may be manually batched upon an operator selecting various jobs and inserting the jobs into batches. In a further embodiment, a manual batching operation is performed by the operator using an input/output device (e.g., a mouse) to drag and drop selected jobs into the batch. As discussed above, batches may be automatically generated upon the occurrence of an automation trigger.

Computer system 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Computer system 500 also may include a read only memory (ROM) and or other static storage device 526 coupled to bus 520 for storing static information and instructions used by processor 510.

A data storage device 525 such as a magnetic disk or optical disc and its corresponding drive may also be coupled to computer system 500 for storing information and instructions. Computer system 500 can also be coupled to a second I/O bus 550 via an I/O interface 530. A plurality of I/O devices may be coupled to I/O bus 550, including a display device 524, an input device (e.g., an alphanumeric input device 523 and or a cursor control device 522). The communication device 521 is for accessing other computers (servers or clients). The communication device 521 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer products, components and/or custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A non-transitory machine-readable medium including data that, when accessed by a machine, cause the machine to perform operations comprising:
receiving a plurality of jobs at a printing environment;
collecting a first set of the plurality jobs at a first filter based on one or more job properties;
generating a first batch of one or more jobs to be processed from a first set of jobs in the first filter, wherein the first batch comprises a subset of jobs included in the first set of jobs having a common secondary attribute; and
generating a second batch of one or more jobs to be processed from a second set of jobs in the first filter, wherein the second batch comprises a subset of jobs included in the first set of jobs having a common tertiary attribute, and wherein the first set of jobs is distinct from the second set of jobs.

2. The machine-readable medium of claim 1 wherein generation of the first batch only occurs after processing of the first set of jobs has been completed and generation of the second batch only occurs after processing of the second set of jobs have been completed.

3. The machine-readable medium of claim 1 wherein the first batch and the second batch each include an identification number associated with the first filter.

4. The machine-readable medium of claim 3 including data that, when accessed by a machine, cause the machine to perform further operations comprising synchronizing the first batch with the second batch based on the identification number.

5. The machine-readable medium of claim 4 including data that, when accessed by a machine, cause the machine to perform further operations comprising simultaneously transmitting the first batch and the second batch to output devices.

6. The machine-readable medium of claim 5 wherein the first batch and the second batch are automatically transmitted to the output devices upon an occurrence of an automation trigger.

7. The machine-readable medium of claim 5 wherein the first batch is transmitted to a first output device and the second batch is transmitted to a second output device.

8. The machine-readable medium of claim 1 including data that, when accessed by a machine, cause the machine to perform further operations comprising defining the first filter, via a graphical user interface (GUI), by:
selecting the one or more job properties specified in the first sub-filter component; and
selecting the one or more job properties specified in the second sub-filter component.

9. The machine-readable medium of claim 8 wherein selecting the one or more job properties comprises selecting one or more job attributes to be shared by the first set of jobs.

10. The machine-readable medium of claim 8 including data that, when accessed by a machine, cause the machine to perform further operations comprising defining the first filter, via the GUI, by:
selecting an automation level for generating the first and second batches; and
selecting an automation trigger indicating conditions for generating the first and second batches.

11. A print server, comprising:
a processor; and
a memory to store a printing software product to be executed by the processor to receive a plurality of jobs at a printing environment, collect a first set of the plurality jobs at a first filter based on one or more job properties, generate a first batch of one or more jobs to be processed from a first set of jobs in the first filter, wherein the first batch comprises a subset of jobs included in the first set of jobs having a common secondary attribute and generate a second batch of one or more jobs to be processed from a second set of jobs in the first filter, wherein the second batch comprises a subset of jobs included in the first set of jobs having a common tertiary attribute, and wherein the first set of jobs is distinct from the second set of jobs.

12. The print server of claim 11 wherein generation of the first batch only occurs after processing of the first set of jobs has been completed and generation of the second batch only occurs after processing of the second set of jobs have been completed.

13. The print server of claim 11 wherein the first batch and the second batch each include an identification number associated with the first filter.

14. The print server of claim 13 wherein the printing software product synchronizes the first batch with the second batch based on the identification number.

15. The print server of claim 14 wherein the printing software product simultaneously transmits the first batch and the second batch to output devices.

16. The print server of claim 15 wherein the first batch and the second batch are automatically transmitted to the output devices upon an occurrence of an automation trigger.

17. The print server of claim 15 wherein the first batch is transmitted to a first output device and the second batch is transmitted to a second output device.

18. The print server of claim 11 wherein the printing software product comprises a graphical user interface (GUI) to define the first filter by selecting the one or more job properties specified in the first sub-filter component and selecting the one or more job properties specified in the second sub-filter component.

19. The print server of claim 18 wherein selecting the one or more job properties comprises selecting one or more job attributes to be shared by the first set of jobs.

20. The print server of claim 18 defining the first filter further comprises selecting an automation level for generating the first and second batches and selecting an automation trigger indicating conditions for generating the first and second batches.
